(19) United States
(12) Patent Application Publication
(10) Pub. No.: US 2022/0318692 A1
(43) Pub. Date: Oct. 6, 2022

(54) INFORMATION PROCESSING DEVICE, STORAGE MEDIUM AND INFORMATION PROCESSING METHOD

(71) Applicant: TOYOTA JIDOSHA KABUSHIKI KAISHA, Toyota-shi (JP)

(72) Inventors: Takayuki OIDEMIZU, Nagakute-shi (JP); Yui OGURA, Nagoya-shi (JP); Shingo TAGUCHI, Nagoya-shi (JP); Yoh IKEDA, Konan-shi (JP); Tatsuya SUZUKI, Nagoya-shi (JP); Tsunehiro YOKOMORI, Toyota-shi (JP)

(73) Assignee: TOYOTA JIDOSHA KABUSHIKI KAISHA, Toyota-shi (JP)

(21) Appl. No.: 17/666,724

(22) Filed: Feb. 8, 2022

(30) Foreign Application Priority Data
Apr. 6, 2021 (JP) 2021-064975

(51) Int. Cl. G06Q 10/02; G06Q 50/30; G06V 20/52; G06V 20/10; G06V 40/16; G06V 10/44; H04W 4/02; H04W 4/40; G08G 1/00

(52) U.S. Cl. CPC G06Q 10/02; G06Q 50/30; G06V 20/52; G06V 20/10; G06V 40/172; G06V 10/44; H04W 4/025; H04W 4/40; G08G 1/202

(57) ABSTRACT

An information processing device that is able to communicate with a user terminal and an imaging device includes: a control unit; and a communication unit. The control unit executes reception of position information from the user terminal via the communication unit, selection of the imaging device around the user terminal from the position information, transmission of an image capturing instruction to the selected imaging device via the communication unit, reception of one or more captured images from the imaging device via the communication unit, recognition of a user of the user terminal from the one or more captured images, and transmission of the captured image in which the user is recognized to a vehicle to be dispatched to the user via the communication unit.

### CROSS-REFERENCE TO RELATED APPLICATION

This application claims priority to Japanese Patent Application No. 2021-064975 filed on Apr. 6, 2021, incorporated herein by reference in its entirety.

### BACKGROUND

### 1. Technical Field

The present disclosure relates to an information processing device, a storage medium, and an information processing method.

### 2. Description of Related Art

Conventionally, there has been a known technique of acquiring a peripheral image of a user from a user terminal provided with an image capturing means and transmitting the acquired peripheral image to a taxi. (For example, refer to Japanese Unexamined Patent Application Publication No. 2002-032897 (JP 2002-032897 A).)

### SUMMARY

Since the peripheral image transmitted to the taxi is an image from the viewpoint of the user, the user himself or herself does not appear in the peripheral image. For this reason, it may be difficult for the taxi driver to specify the location where the user is present.

In view of the above circumstances, an object of the present disclosure is to provide an information processing device, a storage medium, and an information processing method capable of assisting specification of the location where the user is present.

An information processing device according to a first aspect of the present disclosure is an information processing device that is able to communicate with a user terminal and an imaging device, and includes: a control unit; and a communication unit. The control unit executes reception of position information from the user terminal via the communication unit, selection of the imaging device around the user terminal from the position information, transmission of an image capturing instruction to the selected imaging device via the communication unit, reception of one or more captured images from the imaging device via the communication unit, recognition of a user of the user terminal from the one or more captured images, and transmission of the captured image in which the user is recognized to a vehicle to be dispatched to the user via the communication unit.

A storage medium according to a second aspect of the present disclosure stores a program that causes a computer serving as an information processing device that is able to communicate with a user terminal and an imaging device to perform operations including: reception of position information from the user terminal; selection of the imaging device around the user terminal from the position information; transmission of an image capturing instruction to the selected imaging device; reception of one or more captured images from the imaging device; recognition of a user of the user terminal from the one or more captured images; and transmission of the captured image in which the user is recognized to a vehicle to be dispatched to the user.

An information processing method according to a third aspect of the present disclosure is an information processing method executed by an information processing device that is able to communicate with a user terminal and an imaging device, and includes: receiving position information from the user terminal; selecting the imaging device around the user terminal from the position information; transmitting an image capturing instruction to the selected imaging device; receiving one or more captured images from the imaging device; recognizing a user of the user terminal from the one or more captured images; and transmitting the captured image in which the user is recognized to a vehicle to be dispatched to the user.

According to the information processing device, the storage medium, and the information processing method according to each aspect of the present disclosure, it is possible to assist specification of the location where the user is present.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram showing a configuration of an information processing device;

FIG. 3 is a block diagram showing a configuration of a vehicle;

FIG. 4 is a block diagram showing a configuration of a user terminal;

FIG. 5 is a diagram showing a data structure of a characteristic information database (DB);

FIG. 6 is a diagram showing a data structure of a reservation information DB;

FIG. 7 is a diagram showing an example of image capturing;

FIG. 8 shows an example of an captured image; and

FIG. 9 is a sequence diagram showing an operation of the information processing system.

### DETAILED DESCRIPTION OF EMBODIMENTS

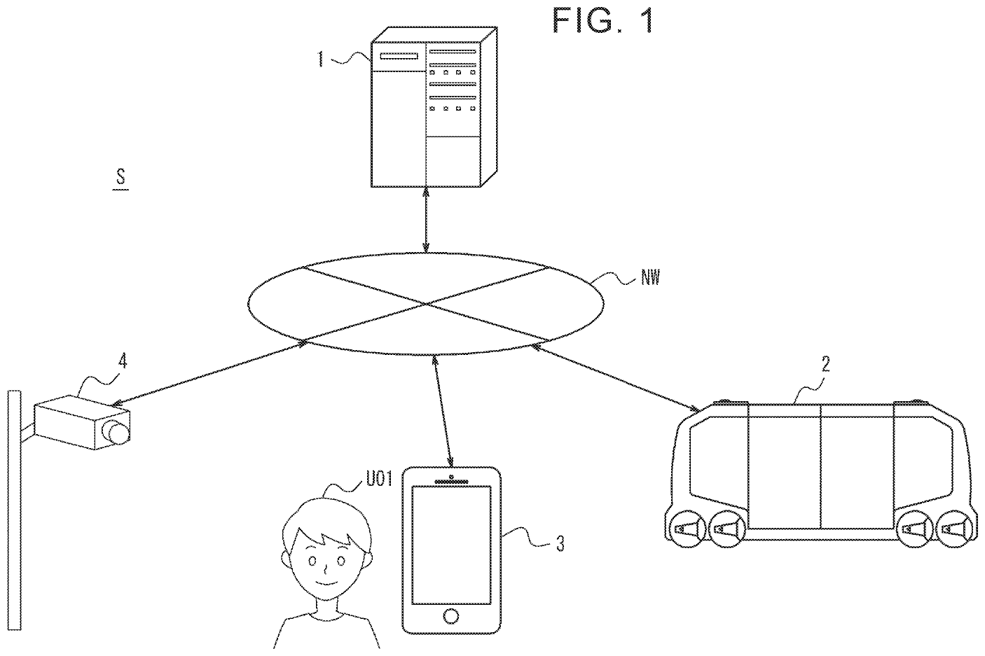

FIG. 1 is a schematic diagram of an information processing system S according to the present embodiment. The information processing system S includes an information processing device 1, a vehicle 2, a user terminal 3, and an imaging device 4 that can communicate with each other via a network NW. The network NW includes, for example, a mobile communication network and the Internet.

In FIG. 1, the information processing device 1, the vehicle 2, the user terminal 3, and the imaging device 4 are each illustrated one by one for the sake of simplicity of description. However, the number of each of the information processing device 1, the vehicle 2, the user terminal 3, and the imaging device 4 is not limited to this. For example, processes executed by the information processing device 1 according to the present embodiment may be executed by a plurality of the information processing devices 1 distributed and arranged. A plurality of the user terminals 3 may be operated by a user U01.

The outline of the processes executed by the information processing device 1 according to the present embodiment will be described below. The control unit 11 of the information processing device 1 receives one or more captured images from the imaging device 4, and recognizes the user in one or more captured images using an arbitrary image analysis method. The control unit 11 transmits the captured image in which the user is recognized to the vehicle 2 to be dispatched to the user. With this configuration, the control unit 11 can provide the vehicle 2 with the captured image in which the user is imaged. Therefore, it is possible to assist the driver of the vehicle 2 to specify an accurate location of the user. As another point of view, the accuracy of the position information may be low in a place where there are many buildings and the like. However, since the captured image in which the user is imaged is provided, it is easy to specify the location of the user. Therefore, the driver of the vehicle 2 can accurately construct a route to pick up the user to a standby place of the user, whereby pick-up of the user in a wrong direction can be reduced.

The information processing device 1 is installed in a facility such as a data center. The information processing device 1 is, for example, a computer such as a server belonging to a cloud computing system or other computing systems. As an alternative example, the information processing device 1 may be mounted on the vehicle 2.

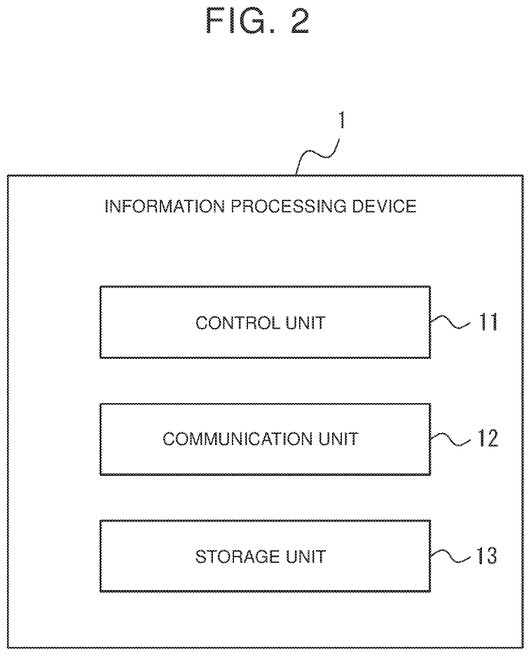

The internal configuration of the information processing device 1 will be described in detail with reference to FIG. 2.

The information processing device 1 includes a control unit 11, a communication unit 12, and a storage unit 13. The constituent components of the information processing device 1 are connected so as to be able to communicate with each other via a dedicated line, for example.

The control unit 11 includes, for example, one or more general-purpose processors including a central processing unit (CPU) or a micro-processing unit (MPU). The control unit 11 may include one or more dedicated processors specialized for a specific process. The control unit 11 may include one or more dedicated circuits instead of the processor. The dedicated circuit may be, for example, a field-programmable gate array (FPGA) or an application-specific integrated circuit (ASIC). The control unit 11 may include an electronic control unit (ECU). The control unit 11 transmits and receives arbitrary information via the communication unit 12.

The communication unit 12 includes a communication module conforming to one or more wired or wireless local area network (LAN) standards for connecting to the network NW. The communication unit 12 may include modules corresponding to one or more mobile communication standards including Long Term Evolution (LTE), the fourth generation (4G), or the fifth generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives arbitrary information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 includes characteristic information DB and reservation information DB, which will be described later.

The vehicle 2 includes any type of vehicles, such as a micromobility, a gasoline vehicle, a diesel vehicle, an HV, a PHV, an EV, or an FCV. The constituent components of the vehicle 2 are communicably connected to each other through an in-vehicle network such as controller area network (CAN) or a dedicated line, for example. The term “HV” is an abbreviation for “hybrid vehicle”. The term “PHV” is an abbreviation for “plug-in hybrid vehicle”. The term “EV” is an abbreviation for “electric vehicle”. The term “FCV” is an abbreviation for “fuel cell vehicle”. The vehicle 2 according to the present embodiment is driven by a driver. As an alternative example, the vehicle 2 may be autonomously driven at any level. The level of driving automation is one of Levels 1 to 5 of SAE levels of driving automation, for example. The term “SAE” is an abbreviation for the “Society of Automotive Engineers”. The vehicle 2 may be a MaaS dedicated vehicle. The term “MaaS” is an abbreviation for “mobility as a service”. The vehicle 2 may be, for example, a bicycle, a motorized bicycle, or a motorcycle.

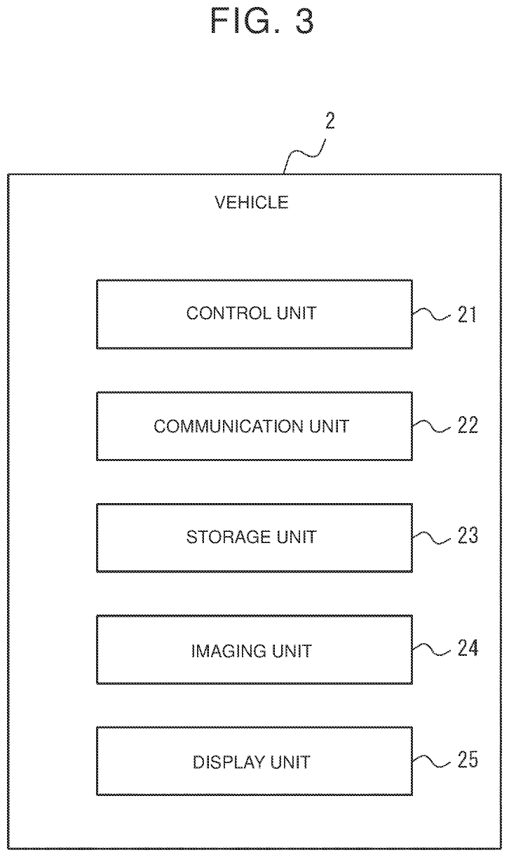

The internal configuration of the vehicle 2 will be described in detail with reference to FIG. 3.

The vehicle 2 includes a control unit 21, a communication unit 22, a storage unit 23, an imaging unit 24, and a display unit 25. The constituent components of the vehicle 2 are connected so as to be able to communicate with each other via, for example, a dedicated line.

The hardware configurations of the control unit 21, the communication unit 22, and the storage unit 23 of the vehicle 2 may be the same as the hardware configurations of the control unit 11, the communication unit 12, and the storage unit 13 of the information processing device 1, respectively. The description herein is omitted.

The imaging unit 24 includes a camera. The imaging unit 24 can capture a peripheral image. The imaging unit 24 may store the captured image in the storage unit 23 or transmit the captured image to the control unit 21 for image analysis.

The display unit 25 is, for example, a display. The display is, for example, a LCD or an organic EL display. The term “LCD” is an abbreviation for “liquid crystal display”. The term “EL” is an abbreviation for “electroluminescence”. The display unit 25 displays information acquired by the operation of the vehicle 2. The display unit 25 may be connected to the vehicle 2 as an external output device instead of being provided in the vehicle 2. As a connection method, for example, any method such as a USB, HDMI (registered trademark), or Bluetooth (registered trademark) can be used. The display unit 25 can display, for example, the captured image and location specifying information received from the information processing device 1.

The user terminal 3 is a terminal operated by the user U01. The user terminal 3 is, for example, a mobile device such as a mobile phone, a smartphone, a wearable device, or a tablet.

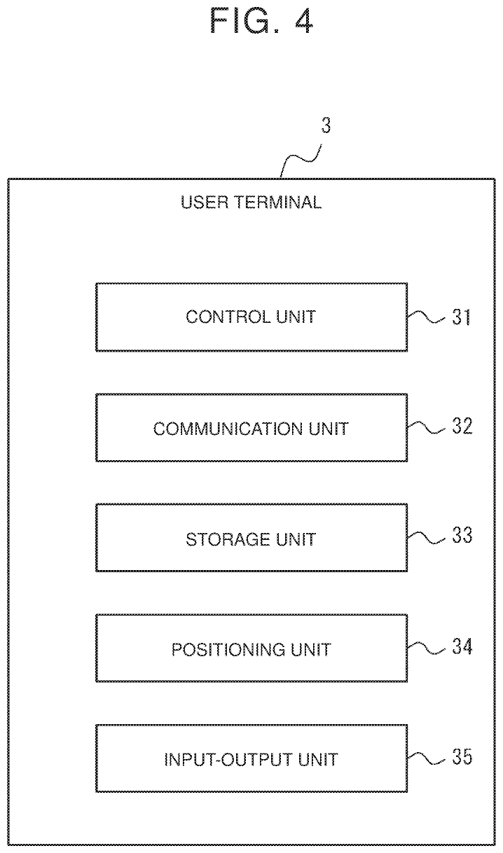

The internal configuration of the user terminal 3 will be described in detail with reference to FIG. 4.

The user terminal 3 includes a control unit 31, a communication unit 32, a storage unit 33, a positioning unit 34, and an input-output unit 35. The constituent components of the user terminal 3 are communicably connected to each other via, for example, a dedicated line.

The hardware configurations of the control unit 31, the communication unit 32, and the storage unit 33 of the user terminal 3 may be the same as the hardware configurations of the control unit 21, the communication unit 22, and the storage unit 23 of the vehicle 2, respectively. The description herein is omitted.

The positioning unit 34 includes at least one GNSS receiver. The “GNSS” is an abbreviation for global navigation satellite system. The GNSS includes, for example, at least one of GPS, QZSS, BeiDou, GLONASS, and Galileo. The “GPS” is an abbreviation for global positioning system. The “QZSS” is an abbreviation for quasi-zenith satellite system. A satellite for the QZSS is referred to as a quasi-zenith satellite. The “GLONASS” is an abbreviation for global navigation satellite system. The positioning unit 34 measures the position of the user terminal 3. The control unit 31 acquires the result of the measurement as position information of the user terminal 3. The “position information” is information with which the position of the user terminal 3 can be specified. The position information includes, for example, an address, latitude, longitude, or altitude.

The input-output unit 35 includes at least one input interface. The input interface is, for example, a physical key, a capacitive key, a pointing device, a touch screen integrated with a display, or a microphone. The input-output unit 35 accepts an operation of inputting information used for the operation of the user terminal 3. The input-output unit 35 may be connected to the user terminal 3 as an external input device instead of being provided in the user terminal 3. As a connection method, for example, any method such as the USB, HDMI (registered trademark), or Bluetooth (registered trademark) can be used. The term “USB” is an abbreviation for “universal serial bus”. The term “HDMI (registered trademark)” is an abbreviation for “high-definition multimedia interface”.

The input-output unit 35 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescence”. The input-output unit 35 outputs the information acquired through the operation of the user terminal 3. The input-output unit 35 may be connected to the user terminal 3 as an external output device instead of being provided in the user terminal 3. As a connection method, for example, any method such as the USB, HDMI (registered trademark), or Bluetooth (registered trademark) can be used.

The imaging device 4 includes a camera. The imaging device 4 can capture a peripheral image. The imaging device 4 may be, for example, a surveillance camera, security camera, or a live camera for observing the weather. The imaging device 4 may be fixed or movable. The imaging device 4 may be a drive recorder mounted on any vehicle. The imaging device 4 transmits the captured image to the information processing device 1 for image analysis.

Hereinafter, the processes executed by the information processing system S according to the present embodiment will be described in detail. Here, a situation where the user U01 of the user terminal 3 requests the dispatch of the vehicle 2 will be described.

The control unit 31 of the user terminal 3 receives input of characteristic information from the user U01 via the input-output unit 35. The characteristic information is information related to the characteristics of the user U01. The characteristic information may include information related to physical characteristics of the user U01. The physical characteristics are characteristics such as a face (e.g., eyes, nose, or mouth), height, or contour.

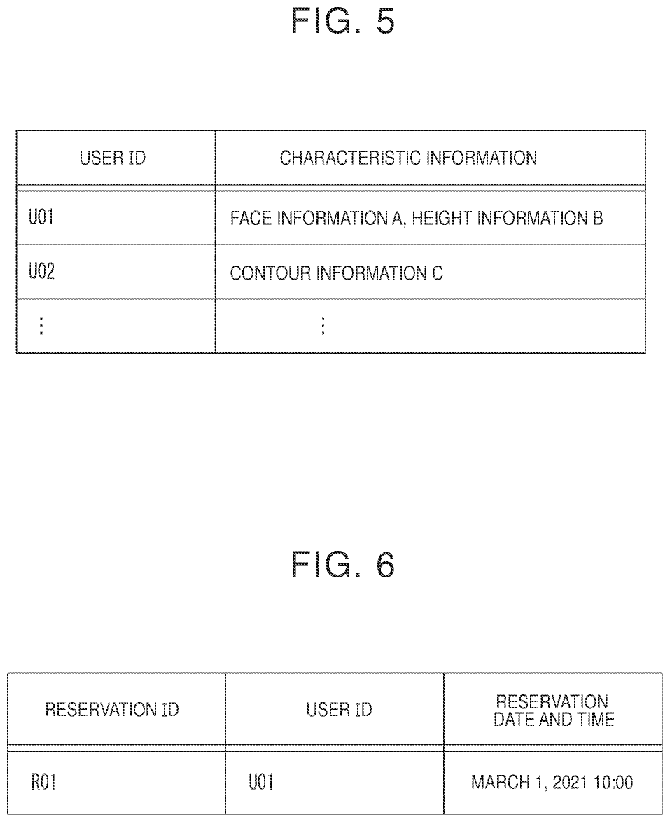

The control unit 31 transmits the characteristic information to the information processing device 1 via the communication unit 32. As shown in FIG. 5, the control unit 11 of the information processing device 1 stores the characteristic information in the characteristic information DB in association with a user identification (ID). In this manner, the characteristic information is registered.

The control unit 31 receives an input of reservation information from the user U01 via the input-output unit 35. The reservation information is information related to reservation of the dispatch of the vehicle 2. The reservation information includes the user ID that is an identifier of the user U01 who has made the reservation and information on the reservation date and time at which the user U01 desires the dispatch of the vehicle.

The control unit 31 transmits the reservation information to the information processing device 1 via the communication unit 32. As shown in FIG. 6, the information processing device 1 stores the reservation information in the reservation information DB in association with a reservation ID. In this manner, the reservation information is registered.

The user U01 stands by at a location where the vehicle 2 is dispatched. When the control unit 31 receives the transmission instruction of the current position, or detects that the current date and time is approaching the reservation date and time, the control unit 31 transmits the information on the current position of the user terminal 3 to the information processing device 1 via the communication unit 32.

The storage unit 13 stores the position information of each of the one or more imaging devices 4. When the information processing device 1 receives the information on the current position of the user terminal 3, the information processing device 1 selects one or more imaging devices 4 around the current position (for example, within a predetermined distance from the current position).

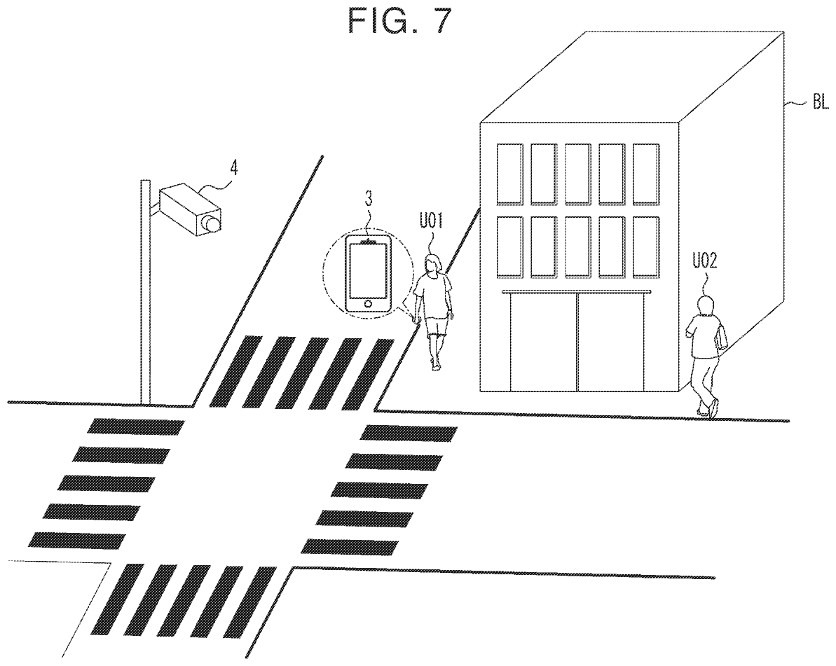

The control unit 11 transmits the image capturing instruction to the selected one or more imaging device 4. As shown in FIG. 7 as an example, the user U01 operating the user terminal 3 is present at the corner where a building BL is present among the four corners at the intersection. A user U02 is present at the corner where the user U01 is present. The imaging device 4 transmits the captured image to the information processing device 1.

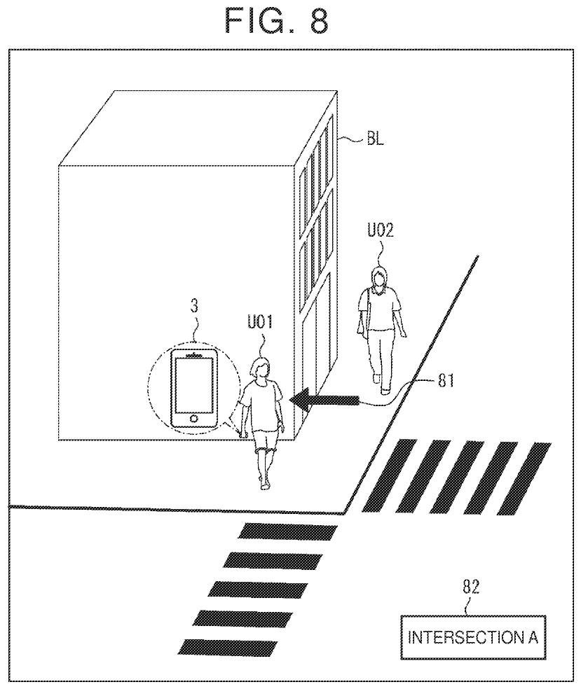

The control unit 11 of the information processing device 1 acquires the characteristic information of the user U01 from the characteristic information DB. The control unit 11 performs image recognition on the captured image using the acquired characteristic information. An example of the captured image in which the user U01 is recognized is shown in FIG. 8. The control unit 11 recognizes the user U01 from the captured image. The control unit 11 specifies the position of the user U01, and generates, for example, the location specifying information as described below.
The user U01 is present on a specific road or at a specific intersection.
The user U01 is present at the corner where a specific object (e.g., the building BL, a tree, or a signboard) is present.
The user U01 is present on a sidewalk located on the north side of a specific road.

As shown in FIG. 8, the control unit 11 superimposes the location specifying information on the captured image in which the user U01 is recognized. The location specifying information may include an emphasis indication 81 of the user U01. The location specifying information may include an annotation 82 that specifies the location of the user.

The control unit 11 specifies a vehicle (here, the vehicle 2) to be dispatched to the user U01. The control unit 11 transmits the captured image on which the location specifying information is superimposed to the vehicle 2 via the communication unit 12.

When the vehicle 2 receives the captured image on which the location specifying information is superimposed, the vehicle 2 displays the captured image on the display unit 25. The driver of the vehicle 2 can specify the location of the user U01 by visually recognizing the location specifying information and arrive in the vicinity of the user U01.

As an alternative example, the control unit 11 may generate the location specifying information in a voice format. The control unit 11 transmits the location specifying information to the vehicle 2 via the communication unit 12. The vehicle 2 can output the location specifying information in a voice format.

In the above-described embodiment, a situation where the vehicle 2 is dispatched has been described. As an alternative example, however, the information processing system S can be applied to situations where it is necessary to specify the location or object that the user is visiting for the first time. Such situations may be, for example, situations with a courier service, a package drop service, or a delivery service. In this case, the above-mentioned characteristic information is, for example, information for specifying the door of the home of the user U01 or the vehicle parked in front of the home. As another alternative example, the information processing system S can be applied to a situation where users wait for each other and a situation where the user picks up or drops off another user.

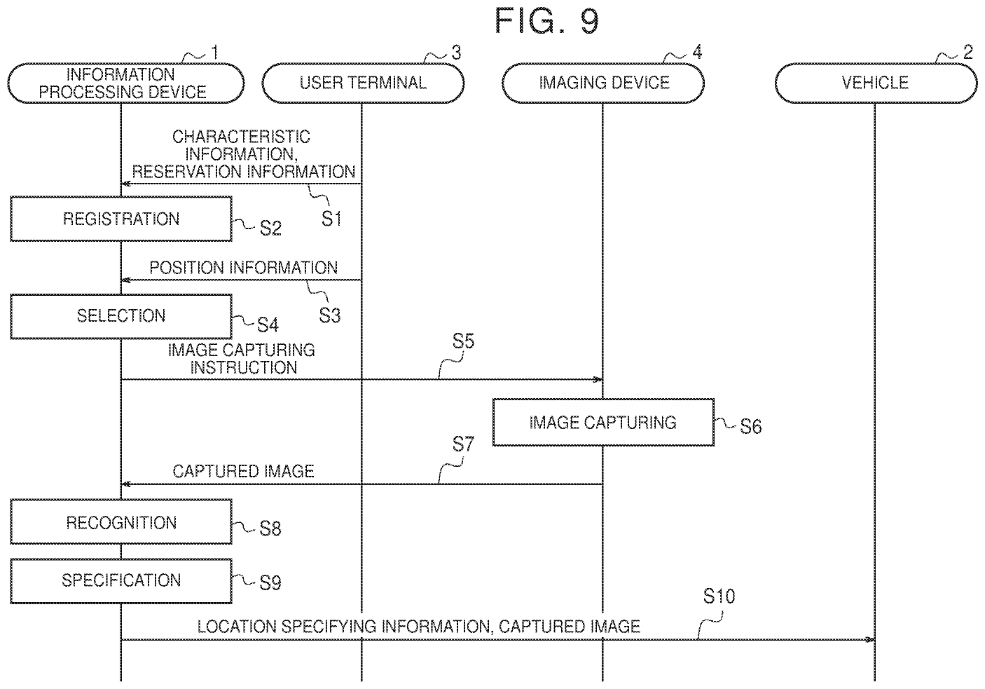

The information processing method executed by the information processing system S according to the present embodiment will be described with reference to FIG. 9.

In step S1, the control unit 11 of the information processing device 1 receives the characteristic information and the reservation information from the user terminal 3 via the communication unit 12. The characteristic information and the reservation information may be received simultaneously or separately.

In step S2, the control unit 11 registers the characteristic information and the reservation information in the storage unit 13.

In step S3, the control unit 11 receives the position information of the user terminal 3 from the user terminal 3.

In step S4, the control unit 11 selects one or more imaging devices 4 around the user terminal 3 from the position information.

In step S5, the control unit 11 transmits the image capturing instruction to the selected imaging device 4.

In step S6, the imaging device 4 captures an image.

In step S7, the imaging device 4 transmits the captured image to the information processing device 1.

In step S8, the control unit 11 recognizes the user U01 of the user terminal 3 from the captured image.

In step S9, the control unit 11 specifies the location of the user U01. The control unit 11 superimposes the location specifying information on the captured image. Whether to superimpose the location specifying information is optional.

In step S10, the control unit 11 transmits the location specifying information and the captured image to the vehicle 2.

According to the present embodiment as described above, the control unit 11 receives one or more captured images from the imaging device 4 and recognizes the user U01 from the one or more captured images. The control unit 11 transmits the captured image in which the user U01 is recognized to the vehicle 2 to be dispatched to the user U01. With this configuration, the control unit 11 can provide the vehicle 2 with the captured image in which the image of the user U01 is captured. Therefore, it is possible to assist the driver of the vehicle 2 to specify the exact location of the user U01. As another point of view, the accuracy of the position information may be low in a place where there are many buildings and the like. However, by providing the captured image in which the image of the user U01 is captured, it is easy to specify the location of the user U01. Therefore, the driver of the vehicle 2 can accurately construct a route to a standby location of the user U01 to pick up the user U01, whereby pick-up of the user in a wrong direction can be reduced.

Further, according to the present embodiment, the control unit 11 further executes reception of the characteristic information of the user U01 from the user terminal 3 and recognition of the user U01 from one or more captured images using the characteristic information. The characteristic information includes information on the physical characteristic of the user U01. With this configuration, the information processing device 1 can increase the recognition accuracy of the user U01.

According to the present embodiment, the control unit 11 further executes generation of the location specifying information for specifying the location where the user U01 is present from the captured image in which the user U01 is recognized, superimposition of the location specifying information on the captured image, and transmission of the captured image to the vehicle 2. The location specifying information includes information on roads, intersections, buildings, trees, or signboards. The location specifying information includes the emphasis indication of the user U01. With this configuration, it is easier to specify the location of the user U01.

Further, according to the present embodiment, the control unit 11 further executes generation of the location specifying information for specifying the location where the user U01 is present in a voice format from the captured image in which the user U01 is recognized, and transmission of the location specifying information to the vehicle 2. With this configuration, it is easier to specify the location of the user U01 even when the vehicle 2 is not provided with a display unit.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each unit or step can be rearranged so as not to be logically inconsistent, and a plurality of units or steps can be combined into one or divided.

For example, in the above embodiment, a program that executes all or part of the functions or processes of the information processing device 1 can be stored in a computer-readable storage medium. The computer-readable storage medium includes a non-transitory computer-readable medium such as a magnetic recording device, an optical disc, a magneto-optical storage medium, or a semiconductor memory. The distribution of the program is performed by, for example, selling, transferring, or lending a portable storage medium such as a digital versatile disc (DVD) or a compact disc read only memory (CD-ROM) on which the program is stored. Further, distribution of the program may be performed by storing the program in a storage of any server and transmitting the program from the server to another computer. Further, the program may be provided as a program product. The present disclosure can also be realized as a program that can be executed by a processor.

The computer temporarily stores the program stored in the portable storage medium or the program transferred from the server in the main storage device, for example. The computer then causes the processor to read the program stored in the main storage device, and causes the processor to execute processes in accordance with the read program. The computer may read the program directly from the portable storage medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and is equivalent to a program. For example, data that is not a direct command to a computer but has the property of defining the processing of the computer corresponds to the “information equivalent to a program”.

What is claimed is:

1. An information processing device that is able to communicate with a user terminal and an imaging device, the information processing device comprising:
a control unit; and
a communication unit, wherein the control unit executes
reception of position information from the user terminal via the communication unit,
selection of the imaging device around the user terminal from the position information,
transmission of an image capturing instruction to the selected imaging device via the communication unit;
reception of one or more captured images from the imaging device via the communication unit,
recognizing a user of the user terminal from the one or more captured images; and
transmission of the captured image in which the user is recognized to a vehicle to be dispatched to the user via the communication unit.

2. The information processing device according to claim 1, wherein the control unit further executes:
reception of characteristic information of the user from the user terminal; and
recognition of the user from the one or more captured images using the characteristic information.

3. The information processing device according to claim 2, wherein the characteristic information includes information relating to a physical characteristic of the user.

4. The information processing device according to claim 1, wherein the control unit further executes:
generation of location specifying information for specifying a location where the user is present from the captured image in which the user is recognized;
superimposition of the location specifying information on the captured image; and
transmission of the captured image to the vehicle.

5. The information processing device according to claim 4, wherein the location specifying information includes information on a road, an intersection, a building, a tree, or a signboard.

6. The information processing device according to claim 4, wherein the location specifying information includes an emphasis indication of the user.

7. The information processing device according to claim 4, wherein the control unit further executes:
generation of the location specifying information for specifying the location where the user is present in a voice format from the captured image in which the user is recognized; and
transmission of the location specifying information to the vehicle.

8. A vehicle equipped with the information processing device according to claim 1.

9. A non-transitory storage medium storing a program that causes a computer serving as an information processing device that is able to communicate with a user terminal and an imaging device to perform operations comprising:
reception of position information from the user terminal;
selection of the imaging device around the user terminal from the position information,
transmitting an image capturing instruction to the selected imaging device;
receiving one or more captured images from the imaging device;
recognition of a user of the user terminal from the one or more captured images; and
transmitting the captured image in which the user is recognized to a vehicle to be dispatched to the user.

10. The storage medium according to claim 9, wherein the program further causes the computer to execute:
reception of characteristic information of the user from the user terminal; and
recognition of the user from the one or more captured images using the characteristic information.

11. The storage medium according to claim 10, wherein the characteristic information includes information relating to a physical characteristic of the user.

12. The storage medium according to claim 9, wherein the program further causes the computer to execute:
generation of location specifying information for specifying a location where the user is present from the captured image in which the user is recognized;
superimposition of the location specifying information on the captured image; and
transmission of the captured image to the vehicle.

13. The storage medium according to claim 12, wherein the location specifying information includes information on a road, an intersection, a building, a tree, or a signboard.

14. The storage medium according to claim 12, wherein the location specifying information includes an emphasis indication of the user.

15. An information processing method executed by an information processing device that is able to communicate with a user terminal and an imaging device, the information processing method comprising:
receiving position information from the user terminal;
selecting the imaging device around the user terminal from the position information;
transmitting an image capturing instruction to the selected imaging device;
receiving one or more captured images from the imaging device;
recognizing a user of the user terminal from the one or more captured images; and
transmitting the captured image in which the user is recognized to a vehicle to be dispatched to the user.

16. The information processing method according to claim 15, further comprising:
receiving characteristic information of the user from the user terminal; and
recognizing the user from the one or more captured images using the characteristic information.

17. The information processing method according to claim 16, wherein the characteristic information includes information relating to a physical characteristic of the user.

18. The information processing method according to claim 15, further comprising:
generating location specifying information for specifying a location where the user is present from the captured image in which the user is recognized;
superimposing the location specifying information on the captured image; and
transmitting the captured image to the vehicle.

19. The information processing method according to claim 18, wherein the location specifying information includes information on a road, an intersection, a building, a tree, or a signboard.

20. The information processing method according to claim 18, wherein
the location specifying information includes an emphasis indication of the user.
